(19) United States
(12) Patent Application Publication
(10) Pub. No.: US 2015/0363858 A1
(43) Pub. Date: Dec. 17, 2015

(54) E-COMMERCE SYSTEM AND METHOD

(71) Applicant: Hudson Fasteners, Inc., Canfield, OH (US)

(72) Inventors: Lisa J. Kleinhandler, Canfield, OH (US); Christine A. Young, Canfield, OH (US)

(21) Appl. No.: 14/304,092

(22) Filed: Jun. 13, 2014

(51) Int. Cl. G06Q 30/06

(52) U.S. Cl. CPC G06Q 30/0627

(57) ABSTRACT

In a method for identifying a product having a combination of attributes, a computer receives data indicative of a selected product, retrieves product data based on selected product, and generates a product grid corresponding to the selected product. The product grid includes a plurality of rows, each corresponding to a value of a first attribute. The product grid further includes a plurality of columns, each corresponding to a value of a second attribute. The product grid further includes a plurality of cells formed by the intersection of the plurality of rows and the plurality of columns, wherein each of the plurality of cells represents the product having a value of the first attribute that corresponds to the intersecting row and a value of the second attribute that corresponds to the intersecting column.

### FIELD OF INVENTION

The present disclosure relates to E-Commerce. More specifically, the present disclosure relates to a system and method for facilitating efficient product search and identification.

### BACKGROUND

E-commerce platforms enable retailers, manufactures, suppliers, wholesalers, distributors, and others involved in selling products to electronically present a catalogue of the products to buyers. An electronic catalogue eliminates the need for a buyer to browse through a physical catalogue or through physical inventory of products. For example, using an example user interface 100 of an e-commerce platform, as illustrated in FIG. 1, a consumer may drill down into categories 102 and subcategories 104 of products before being presented with a list 106 of products within the selected subcategory. The list or products may be presented on a single page or the list may span multiple pages depending on the number of products to be displayed. The e-commerce platform enables scrolling through the list 106 of products and moving to a next page 108 in order to continue to browse the list when a larger list spans multiple pages.

In some industries, however, a product or family of products may include a large variety of models, shapes, sizes, colors, and so on. For example, in the fastener industry, a single type of screw such as a hex cap screw may be available in ten or more diameters and in ten or more lengths. Moreover, the screw may be available in several different types of materials or finishes such as steel, bronze, and so on. Thus, there may be thousands or more options available for selecting a single type of screw. In addition, a seller of fasteners may offer many different types of screws, all of which may be available in a different diameters, lengths, and finishes. Accordingly, because of the large number of available products, it may be inefficient and time consuming for a consumer to scroll through a list of products on an e-commerce platform, which may span multiple pages. In addition, it may be difficult and confusing for a consumer to search for and identify a desired product by scrolling through multiple pages of products.

### SUMMARY OF THE INVENTION

An ecommerce system for identifying a product having a combination of attributes includes at least one processor, at least one computer-readable tangible storage device, and program instructions stored on the at least one storage device for execution by the at least one processor. The program instructions include first program instructions configured to receive data indicative of a selected product. The program instructions further include second program instructions configured to retrieve product data based on selected product. The program instructions further include third program instructions configured to generate a product grid corresponding to the selected product. The product grid includes a plurality of rows, each corresponding to a value of a first attribute. The product grid further includes a plurality of columns, each corresponding to a value of a second attribute. The product grid further includes a plurality of cells formed by the intersection of the plurality of rows and the plurality of columns, wherein each of the plurality of cells represents the product having a value of the first attribute that corresponds to the intersecting row and a value of the second attribute that corresponds to the intersecting column.

In a method for identifying a product having a combination of attributes, a computer receives data indicative of a selected product, retrieves product data based on selected product, and generates a product grid corresponding to the selected product. The product grid includes a plurality of rows, each corresponding to a value of a first attribute. The product grid further includes a plurality of columns, each corresponding to a value of a second attribute. The product grid further includes a plurality of cells formed by the intersection of the plurality of rows and the plurality of columns, wherein each of the plurality of cells represents the product having a value of the first attribute that corresponds to the intersecting row and a value of the second attribute that corresponds to the intersecting column.

A computer program product for identifying a product having a combination of attributes includes at least one computer-readable tangible storage device and program instructions stored on the at least one storage device. The program instructions include first program instructions configured to receive data indicative of a selected product. The program instructions further include second program instructions configured to retrieve product data based on selected product. The program instructions further include third program instructions configured to generate a product grid corresponding to the selected product. The product grid includes a plurality of rows, each corresponding to a value of a first attribute. The product grid further includes a plurality of columns, each corresponding to a value of a second attribute. The product grid further includes a plurality of cells formed by the intersection of the plurality of rows and the plurality of columns, wherein each of the plurality of cells represents the product having a value of the first attribute that corresponds to the intersecting row and a value of the second attribute that corresponds to the intersecting column.

### BRIEF DESCRIPTION OF THE DRAWINGS

In the accompanying drawings, structures are illustrated that, together with the detailed description provided below, describe exemplary embodiments of the claimed invention. It should be understood that elements shown as a single component may be replaced with multiple components, and elements shown as multiple components may be replaced with a single component. The drawings are not to scale and the proportion of certain elements may be exaggerated for the purpose of illustration.

FIG. 1 illustrates an example user interface of a known e-commerce platform.

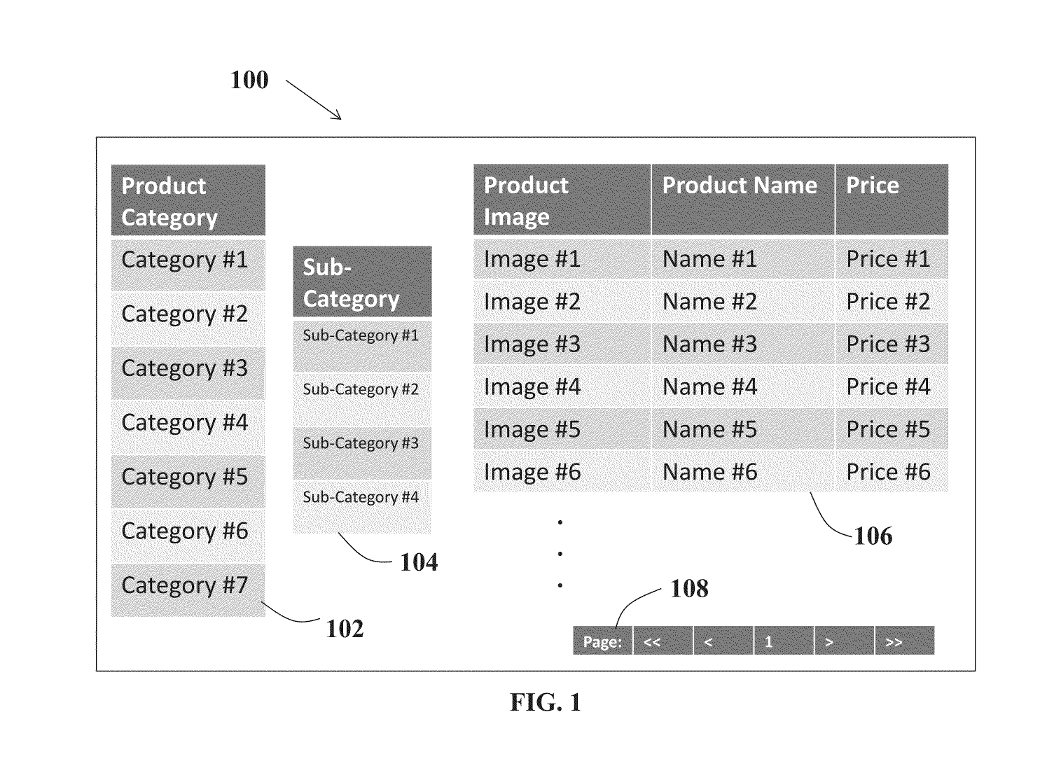

FIG. 2 illustrates an example user interface of an example e-commerce system for facilitating efficient product search and identification.

FIG. 3 illustrates a block diagram of an example e-commerce system 300 for facilitating efficient product search and identification.

FIG. 4 illustrates the steps of an example e-commerce method.

FIG. 5 is a block diagram of an example computing system for implementing an example e-commerce system of FIG. 3.

### DETAILED DESCRIPTION

The following includes definitions of selected terms employed herein. The definitions include various examples, forms, or both of components that fall within the scope of a term and that may be used for implementation. The examples are not intended to be limiting. Both singular and plural forms of terms may be within the definitions.

“Computing device,” as used herein, refers to a laptop computer, a desktop computer, a smartphone, a personal digital assistant, a cellular telephone, a tablet computer, an eReader, or the like.

“Computer-readable medium,” as used herein, refers to a medium that participates in directly or indirectly providing signals, instructions, or data. A computer-readable medium may take forms, including, but not limited to, non-volatile media, volatile media, and transmission media. Non-volatile media may include, for example, optical or magnetic disks, and so on. Volatile media may include, for example, optical or magnetic disks, dynamic memory, and the like. Transmission media may include coaxial cables, copper wire, fiber optic cables, and the like. Transmission media can also take the form of electromagnetic radiation, like that generated during radio-wave and infra-red data communications, or take the form of one or more groups of signals. Common forms of a computer-readable medium include, but are not limited to, a floppy disk, a flexible disk, a hard disk, a magnetic tape, other magnetic media, a CD-ROM, other optical media, punch cards, paper tape, other physical media with patterns of holes, a RAM, a ROM, an EPROM, a FLASH-EPROM, or other memory chip or card, a memory stick, a carrier wave/pulse, Phase Change Memory, and other media from which a computer, a processor, or other electronic device can read. Signals used to propagate instructions or other software over a network, like the Internet, can be considered a “computer-readable medium.”

“Logic,” as used herein, includes but is not limited to hardware, firmware, software, or combinations of each to perform a function(s) or an action(s), or to cause a function or action from another logic, method, or system. For example, based on a desired application or needs, logic may include a software controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

“Software,” as used herein, includes but is not limited to, one or more computer or processor instructions that can be read, interpreted, compiled, or executed and that cause a computer, processor, or other electronic device to perform functions, actions, or behave in a desired manner. The instructions may be embodied in various forms like routines, algorithms, modules, methods, threads, or programs including separate applications or code from dynamically or statically linked libraries. Software may also be implemented in a variety of executable or loadable forms including, but not limited to, a stand-alone program, a function call (local or remote), a servelet, an applet, instructions stored in a memory, part of an operating system, or other types of executable instructions. The form of software may depend, for example, on requirements of a desired application, the environment in which it runs, or the desires of a designer/programmer or the like. Computer-readable or executable instructions can be located in one logic or distributed between two or more communicating, co-operating, or parallel processing logics and, thus, can be loaded or executed in serial, parallel, massively parallel, and other manners. One form of software is an app, or an application that executes on a mobile computing device such as a mobile phone.

Suitable software for implementing the various components of the example systems and methods described herein may be produced using programming languages and tools like Haskell, Java, Java Script, Java.NET, ASP.NET, VB.NET, Cocoa, Pascal, C#, C++, C, CGI, Perl, SQL, APIs, SDKs, assembly, firmware, microcode, or other languages and tools. Software, whether an entire system or a component of a system, may be embodied as an article of manufacture and maintained or provided as part of a computer-readable medium. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

“User” or “consumer,” as used herein, includes but is not limited to one or more persons, software, computers or other devices, or combinations of these.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, logic, processor, or similar electronic device that manipulates and transforms data represented as physical (electronic) quantities.

Disclosed and described herein is an e-commerce system and method for facilitating efficient product search and identification in industries such as industrial supply where products may include many forms, shapes, sizes, colors, and so on. It should be appreciated that although the example embodiments described herein may refer to the fastener industry specifically, the example e-commerce system and method may be used to facilitate efficient product search and identification in any suitable industry or product category.

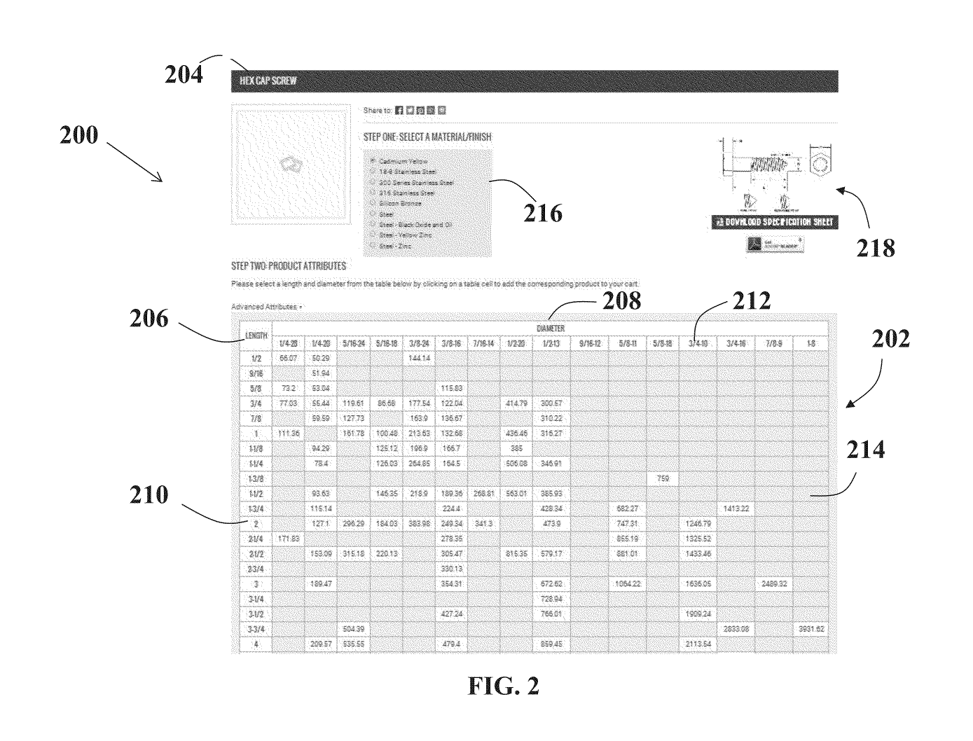

FIG. 2 illustrates an example user interface 200 of an example e-commerce system for facilitating efficient product search and identification. User interface 200 includes a product grid 202 that corresponds to a selected product. The selected product, such as hex cap screw, is displayed in a product label 204. Product label 204 may include a name of a product, an image of the product, or both. A product may be selected from a group of products using any suitable user interface (not shown). For example, a product may be selected from a list of products by clicking on a product name, by selecting a product from a drop-down list, by checking a check-box, and so on.

The product grid 202 is configured to display a first attribute 206 of the product along the vertical axis and a second attribute 208 of the product along the horizontal axis. For example, a first attribute 206 may be the length of the product and the second attribute 208 may be the diameter of the product. It should be understood that product grid 202 may include any suitable attributes such as height, weight, color, material, and so on.

Product grid 202 includes multiple rows 210 corresponding to different values of the first attribute 206. Product grid 202 includes multiple columns 212 corresponding to different values of the second attribute 208. It should be appreciated that product grid 202 may include any suitable number of rows 210 and columns 212.

The rows 210 and columns 212 intersect to form cells 214, each of which represent the selected product having a different combination of values of the first attribute and the second attribute 206 and 208. Thus, a cell 214 that is intersected by a first row corresponding to a first value of the first attribute 206 and a first column corresponding to a first value of the second attribute 208 represents the selected product having a first value of the first attribute 206 and a first value of the second attribute 208. For example, if a first row corresponds to hex cap screws having a one inch length and a first column corresponds to hex cap screws having a quarter inch diameter, a cell intersected by the first row and the first column corresponds to a hex cap screw having a one inch length and a quarter inch diameter.

Cells 214 that correspond to products having certain combinations of attributes that are available, or are being offered for sale by the seller, may be differentiated from cells that correspond to products having certain combinations of attributes that are not available, or are not being offered for sale by the seller. For example, a column corresponding to hex cap screws having a quarter inch diameter may intersect with 3 rows corresponding to hex cap screws having lengths of 1 inches, 2 inches, and 3 inches respectively. However, a seller may only offer hex cap screws having a quarter inch diameter in 1 inch and 3 inch lengths but not in a 2 inch length. Accordingly, the cells that are formed at the intersections of the column corresponding to the quarter inch hex cap screw with the rows corresponding to the 1 inch and 3 inch hex cap screws may be differentiated from the cell that is formed at the intersection of the column corresponding to the quarter inch hex cap screw with the row corresponding to the 2 inch hex cap screw.

The differentiation may be achieved in any suitable way. For example, cells corresponding to products being available in a particular combination of attributes may be displayed in a first color while cells corresponding to products not being available in a particular combination of attributes may be displayed in a second color. In one example, a symbol such as a red “x” or a green check mark may be used to make the distinction. In another example, a number may be used to make the distinction. For example, a number displayed in a cell may indicate the price of the product having the particular combination of attributes while an empty cell with no number may indicate that the product is not available with the corresponding combination of attributes. In another example, a cell with a number may indicate the quantity available in the seller's inventory while a cell without a number may indicate lack of availability. In another example, the number may indicate a product serial number. In another example, cells corresponding to available products may include an image of the product, or another graphic, while cells corresponding to unavailable products may not include an image or be empty.

User interface 200 also includes a product filter window 216 that enables a user to filter the product grid 202 according to a selected attribute. For example, product filter window 216 may enable a user to select a material or finish of a product. Specifically, product filter window 216 may include selections such as cadmium, stainless steel, silicon bronze, and so on. Product filter window 216 may include a dropdown list, check-boxes, radio buttons, links, other suitable interface means for selecting an item from a group of items. Product grid 202 is configured to display the product having various combinations of attributes based on a selected attribute in product filter window 216. When a material or other suitable attribute is selected in product filter window 216, product grid 202 is configured to automatically update the displayed information. For example, a 1 inch length and a quarter inch diameter hex cap screw may be available in cadmium yellow but may not be available in stainless steel. Thus, product grid 202 is configured to update a cell associated with a 1 inch length and a quarter inch diameter hex cap screw accordingly when cadmium material selected or when stainless steel is selected. In one example, a default attribute in product filter window 216 is pre-selected when a product category is first selected and user interface 200 first loads the product grid 202. It should be appreciated that product filter window 216 may be configured to provide a consumer an option of selecting one or more attributes, other than material.

Product grid 202 in combination with product filter window 216 provide a consumer with an interface for efficiently identifying a desired product having a specific set of attributes by providing the consumer with the ability to view the availability of various combinations of attributes for a selected product within a single page without having to scroll through and navigate between large amounts of data spanning multiple pages or displays.

In one example, product grid 202 is configured to enable a consumer to select and add a product having a particular combination of attributes to a shopping cart. For example, a mouse-click on a cell 214 may cause a product having a particular combination of attributes associated with the cell 214 to be added to a shopping cart (not shown). In another example, clicking on a cell 214 may cause a prompt, a popup window, or other suitable interface for receiving data input (not shown) to appear in order to request the consumer to confirm the intention to add the product to a shopping cart. In one example, the prompt also asks the consumer to confirm a quantity to add to the shopping cart. In one example, product grid 202 is configured to display suitable product information about a product inside a cell 214, or in a pop-up display, when a mouse or other suitable user input device hovers over the cell 214 or when the cell 214 is clicked.

In one example, user interface 200 includes an information display 218, configured to display suitable information about a product associated with a cell 214 when a cell 214 is selected by a consumer. In one example, information display 218 may include a link to a document containing suitable product information such as product specifications.

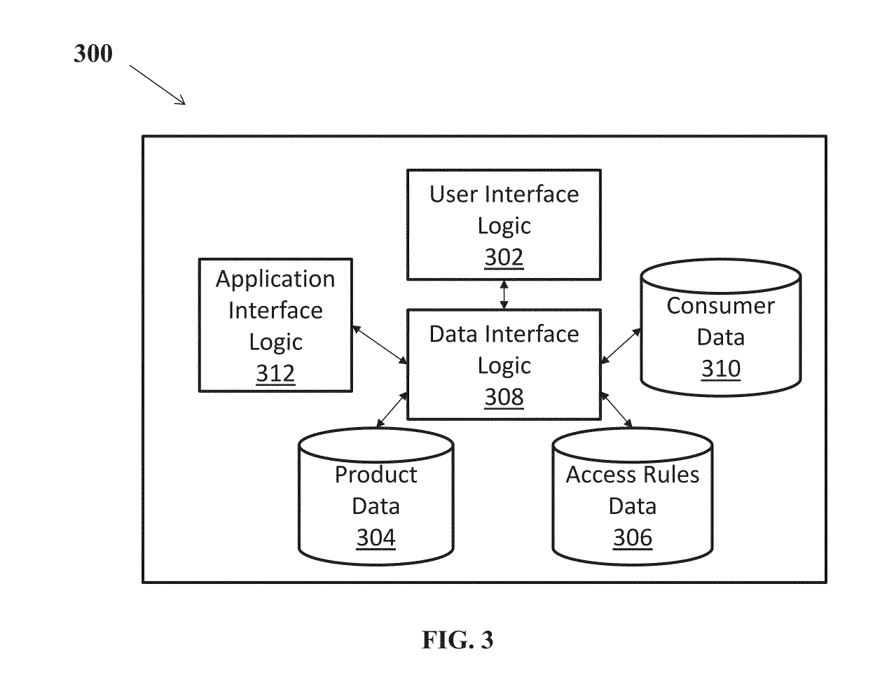

FIG. 3 illustrates a block diagram of an example e-commerce system 300 for facilitating efficient product search and identification. E-commerce system 300 includes user interface logic 302 configured to present user interface 200 to a user via a display device (not shown). User interface logic 302 is configured to communicate information to the user and also to receive information from the user via user interface 200.

E-commerce system 300 includes product data 304. Product data 304 may include a database, a flat file, or other suitable data storage means for storing information about various products to be sold via the e-commerce system 300.

In one example, product data 304 includes one or more keywords associated with one or more products to allow for improved product search and identification. For example, a product may be commonly referred to by one of several different names. Accordingly, product data 304 may associate the several different names with the product so that a user may easily identify the product when performing a search.

E-commerce system 300 includes access rules data 306. Access rules data 306 may include a database, a flat file, or other suitable data storage means for storing rules that define how data is accessed from product data 304 and presented to a user by user interface logic 302.

In one example, access rules data 306 includes rules that define what products are presented to the user or consumer. For example, depending on whether a consumer is a distributor, an original equipment manufacturer, a wholesaler, an electrical contractor, a retail consumer, and so on, user interface logic 302 may present different subsets or combinations of products. In particular, a first type of consumer may be interested in seeing a first subset of products while a second type of consumer may be interested in seeing a second subset of products. Moreover, a retailer may wish to only present a certain subset of products to a specific type of consumer while preventing other types of consumers from seeing the same subset of products. Accordingly, access rules data 306 includes rules that define the products that are made visible to different types of consumers. In one example, certain products may be displayed only to verified or certified consumers.

In one example, access rules data 306 includes rules that define whether certain information about a product is made visible to a consumer depending on the type of consumer. For example, the price of a product may be made visible via user interface 200 when a first type of consumer interacts with the e-commerce system 300 while the price may be hidden or omitted from user interface 200 when a second type of consumer interacts with the e-commerce system 300. When a price is hidden or omitted, text such as “call for price” or other suitable text or graphic may be displayed in place of a price.

In one example, access rules data 306 includes rules that define what information about a product is made visible to a consumer depending on the type of consumer. For example, information such as price may be displayed differently to different consumers. Specifically, a seller may choose to offer a discount to certain consumers. Thus, a first price may be presented via the user interface 200 to a first type of consumer while a second price, different than the first price, may be presented via the user interface 200 to a second type of consumer.

In one example, access rules data 306 may include rules that define how to customize a repeat customer's experience by presenting a modified user interface 200 based on previous purchases made by the consumer. For example, if a consumer previously purchased a certain product, access rules data 306 may include a rule that directs user interface logic 302 to present the same product as a suggestion to the consumer upon the same user interacting with the e-commerce system 300 during a future time. In another example, access rules data 306 may include a rule that defines a discount price on a certain product if a consumer previously purchased a certain product.

E-commerce system 300 includes a data interface logic 308 configured to retrieve information about products from product data 304, based on rules stored in access rules data 306, and to communicate the data to user interface logic 302. In one example, data interface logic 308 is configured to retrieve data from product data 304 and to store it in virtual memory. Data interface logic 308 is further configured to generate a subset of the data stored in virtual memory, based on one or more rules retrieved from access data rules data 306. Data interface logic 308 is configured to communicate the subset of data to user interface logic 302. The subset of data can be stored in virtual memory, in a database (not shown), or using any suitable data storage means.

Data interface logic 308 is configured to determine which one or more rules of access rules data 306 to retrieve based on the type of consumer currently interacting with e-commerce system 300 via user interface 200. For example, data interface logic 308 may retrieve a first pricing display rule when a first type of consumer is interacting with e-commerce system 300 while data interface logic 308 may retrieve a second pricing display rule when a second type of consumer is interacting with e-commerce system 300.

Data interface logic 308 is configured to identify the type of consumer currently interacting with e-commerce system 300 based on information received via user interface logic 302. In one example, user interface logic 302 is configured to receive user registration information via interface 200 and to communicate the user registration information to data interface logic 308. E-commerce system may include consumer data 310 for storing information about registered or certified consumers. Accordingly, data interface logic may be configured to retrieve consumer information from consumer data 310, according to registration information received from user interface logic 302, and to retrieve corresponding access rules from access rules data 306. In one example, data interface logic 308 may be configured to automatically verify a consumer by communicating consumer registration information to a verification service provider (not shown) and waiting for a response from the verification service provider.

In one example, data interface logic 308 is configured to identify a type of consumer currently interacting with the e-commerce system 300 based on the landing page, web portal, or user interface with which the consumer is interacting with e-commerce system 300 and thereby communicating information to user interface logic 302. For example, a first web portal having a first Internet Web address may be provided to retail customers for accessing e-commerce system 300 while a second web portal having a second Internet Web address may be provided to distributors for accessing e-commerce system 300. Accordingly, data interface logic 308 is configured to differentiate information received via user interface logic 302 from the first web portal as compared to information received via user interface logic 302 from the second web portal in order to differentiate between retail customers and distributors.

In one example, e-commerce system 300 includes an application interface logic 312 configured to provide one or more program applications (now shown) with access to the data interface logic 308. Application interface logic 312 enables third party applications and system to access the product data 304 via data interface logic 308, similar to the way user interface logic 302 does, when appropriate permission is granted to the third party system. In one example, access permissions and credentials for third party system may be stored in consumer data 310. Accordingly, data interface logic 308 may be configured to access consumer data 310 to verify a request made via application interface logic 312 before communicating product data to a third party system via application interface program 312.

It should be appreciate that although data interface logic 308 and application interface logic 312 are depicted as two separate logic components, they can be combined into a single component configured to access and communicate product data to user interface 200 or to third party systems (not shown). The combined logic can be a class library, for example.

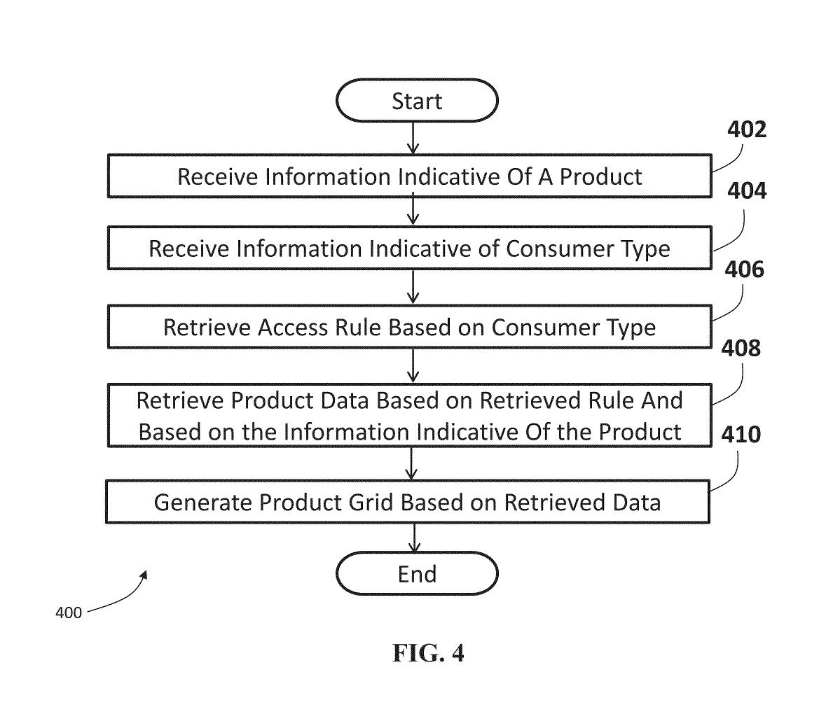

FIG. 4 illustrates the steps of an example e-commerce method 400. At step 402, user interface logic 302 receives information indicative of a selected product family or category. At step 404, user interface 302 receives information indicative of a the type of consumer currently interacting with e-commerce system 300. At step 406, data interface logic 308 retrieves one or more rules from access rules data 306 based on the received information indicative of the consumer type. At step 408, data interface logic 308 retrieves product data from product data 304 based on the one or more retrieved rules and based on the received information indicative of the product. At step 410, user interface logic 302 generates a product grid 202, based on the product data retrieved by data interface logic 308 and communicate the product grid 202 to user interface 200.

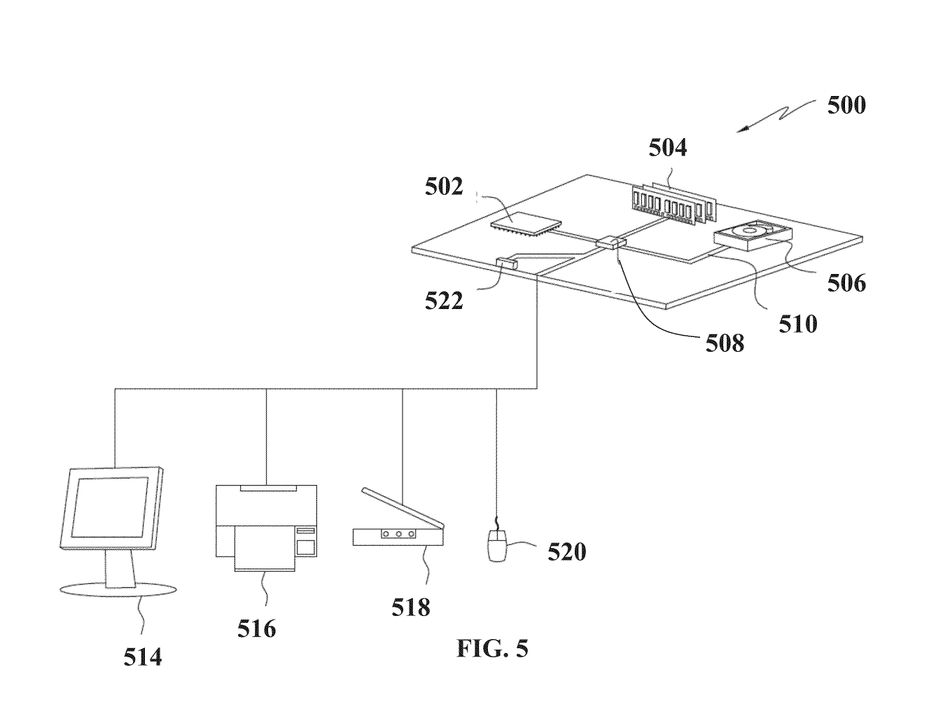

FIG. 5 is a block diagram of an example computing system 500 for implementing an example e-commerce system. The example computing system 500 is intended to represent various forms of digital computers, including laptops, desktops, handheld computers, smartphones, tablet computers, servers, and other similar types of computing devices. As shown, computing system 500 includes a processor 502, memory 504, a storage device 506, and a communication port 522, operably connected by an interface 508 via a bus 510.

Processor 502 processes instructions, via memory 504, for execution within computing system 500. In an example embodiment, multiple processors along with multiple memories may be used.

Memory 504 may be volatile memory or non-volatile memory. Memory 504 may be a computer-readable medium, such as a magnetic disk or optical disk. Storage device 506 may be a computer-readable medium, such as floppy disk devices, a hard disk device, optical disk device, a tape device, a flash memory, phase change memory, or other similar solid state memory device, or an array of devices, including devices in a storage area network of other configurations. A computer program product can be tangibly embodied in a computer readable medium such as memory 504 or storage device 506.

Computing system 500 may be coupled to one or more input and output devices such as a display 514, a printer 516, a scanner 518, and a mouse 520.

While example systems, methods, and so on, have been illustrated by describing examples, and while the examples have been described in considerable detail, it is not the intention to restrict or in any way limit the scope of the appended claims to such detail. It is simply not possible to describe every conceivable combination of components or methodologies for purposes of describing the systems, methods, and so on. With the benefit of this application, additional advantages and modifications will readily appear to those skilled in the art. The scope of the invention is to be determined by the appended claims and their equivalents.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

1. An ecommerce system for identifying a product having a combination of attributes, the system comprising:
at least one processor, at least one computer-readable tangible storage device, and program instructions stored on the at least one storage device for execution by the at least one processor, the program instructions comprising:
first program instructions configured to receive data indicative of a selected product category comprising a plurality of products;
second program instructions configured to retrieve product data based on the selected product category;
third program instructions configured to generate a product grid corresponding to the selected product category, wherein the product grid comprises:
a plurality of rows, each corresponding to a value of a first attribute;
a plurality of columns, each corresponding to a value of a second attribute; and
a plurality of cells each formed by an intersection of one of the plurality of rows and one of the plurality of columns, wherein each of the plurality of cells represents one of the plurality of products having a value of the first attribute that corresponds to the one of the plurality of rows and a value of the second attribute that corresponds to the one of the plurality of columns that intersect to form the cell;
fourth program instructions configured to display the product grid;
fifth program instructions configured to receive input via one of the plurality of cells indicative of a selection of the one of the plurality of cells; and
sixth program instructions configured to add to a shopping cart the product represented by the selected cell.

2. The ecommerce system of claim 1, wherein the program instructions further comprise seventh program instructions configured to receive data indicative of a consumer type and to retrieve at least one data access rule corresponding to the consumer type, and wherein the second program instructions are configured to retrieve product data based on the selected product category and based on the at least one data access rule.

3. The ecommerce system of claim 1, wherein the third program instructions are further configured to differentiate a first of the plurality of cells corresponding to a first of the plurality of products having a first combination of first and second attribute values that is available for sale from a second of the plurality of cells corresponding to a second of the plurality of products having a second combination of first and second attribute values that is not available for sale.

4. The ecommerce system of claim 3, wherein the third program instructions are further configured to differentiate the first of the plurality of cells and the second of the plurality of cells with at least one of a color, a number, a symbol, and an image.

5. The ecommerce system of claim 1, wherein the program instructions further comprise seventh program instructions configured to receive data indicative of a selected attribute and to filter the retrieved product data based on the selected attribute.

6. (canceled)

7. The ecommerce system of claim 1, wherein the program instructions further comprise:
seventh program instructions configured to display specifications associated with the product having the first and the second attribute values corresponding to the selected cell.

8. A computer-implemented method for identifying a product having a combination of attributes, the method comprising executing on at least one processor the steps of:
receiving data indicative of a selected product category comprising a plurality of products;
retrieving product data based on selected product category;
generating a product grid corresponding to the selected product category, wherein the product grid comprises:
a plurality of rows, each corresponding to a value of a first attribute;
a plurality of columns, each corresponding to a value of a second attribute; and
a plurality of cells each formed by an intersection of one of the plurality of rows and one of the plurality of columns, wherein each of the plurality of cells represents one of the plurality of products having a value of the first attribute that corresponds to the one of the plurality of rows and a value of the second attribute that corresponds to the one of the plurality of columns that intersect form the cell;
displaying the product grid;
receiving input via one of the plurality of cells indicative of a selection of the one of the plurality of cells; and
adding to a shopping cart the product represented by the selected cell.

9. The method of claim 8, further comprising executing on the at least one processor the steps of:
receiving data indicative of a consumer type; and
retrieving at least one data access rule corresponding to the consumer type;
wherein the product data is retrieved based on the selected product category and based on the at least one data access rule.

10. The method of claim 8, wherein the step of generating the product grid further comprises differentiating a first of the plurality of cells corresponding to a first of the plurality of products having a first combination of first and second attribute values that is available for sale from a second of the plurality of cells corresponding to a second of the plurality of products having a second combination of first and second attribute values that is not available for sale.

11. The method of claim 9, further comprising executing on the at least one processor the step of differentiating the first of the plurality cells and the second of the plurality of cells with at least one of a color, a number, a symbol, or an image.

12. The method of claim 8, further comprising executing on the at least one processor the steps of receiving data indicative of a selected attribute and filtering the retrieved product data based on the selected attribute.

13. (canceled)

14. The method of claim 8, further comprising executing on the at least one processor the step of:
displaying specifications associated with the product having the first and the second attribute values corresponding to the selected cell.

15. A computer program product for identifying a product having a combination of attributes, the computer program product comprising at least one computer-readable tangible storage device and program instructions stored on the at least one storage device, the program instructions comprising:
first program instructions configured to receive data indicative of a selected product category comprising a plurality of products;
second program instructions configured to retrieve product data based on selected product category;
third program instructions configured to generate a product grid corresponding to the selected product category, wherein the product grid comprises:
a plurality of rows, each corresponding to a value of a first attribute;
a plurality of columns, each corresponding to a value of a second attribute; and
a plurality of cells each formed by an intersection one of the plurality of rows and one of the plurality of columns, wherein each of the plurality of cells represents one of the plurality of products having a value of the first attribute that corresponds to the one of the plurality of rows and a value of the second attribute that corresponds to the one of the plurality of columns that intersect to form the cell;
fourth program instructions configured to display the product grid;
fifth program instructions configured to receive input via one of the plurality of cells indicative of a selection of the one of the plurality of cells; and
sixth program instructions configured to add to a shopping cart the product represented by the selected cell.

16. The computer program product of claim 15, wherein the program instructions further comprise seventh program instructions configured to receive data indicative of a consumer type and to retrieve at least one data access rule corresponding to the consumer type, and wherein the second program instructions are configured to retrieve product data based on the selected product category and based on the at least one data access rule.

17. The computer program product of claim 15, wherein the third program instructions are further configured to differentiate a first of the plurality of cells corresponding to a first of the plurality of products having a first combination of first and second attribute values that is available for sale from a second of the plurality of cells corresponding to a second of the plurality of products having a second combination of first and second attribute values that is not available for sale.

18. The computer program product of claim 15, wherein the program instructions further comprise seventh program instructions configured to receive data indicative of a selected attribute and to filter the retrieved product data based on the selected attribute.

19. (canceled)

20. The computer program product of claim 15, wherein the program instructions further comprise:
seventh program instructions configured to display specifications associated with the product having the first and the second attribute values corresponding to the selected cell.

21. The ecommerce system of claim 1, wherein the program instructions further comprise seventh program instructions configured to cause a popup window that interfaces with the shopping cart to be displayed in response to the input being received via the one of the plurality of cells.

22. The method of claim 8, further comprising executing on the at least one processor the step of to causing a popup window that interfaces with the shopping cart to be displayed in response to the input being received via the one of the plurality of cells.

23. The computer program product of claim 15, wherein the program instructions further comprise seventh program instructions configured to cause a popup window that interfaces with the shopping cart to be displayed in response to the input being received via the one of the plurality of cells.
